(19) United States
(12) Patent Application Publication
(10) Pub. No.: US 2003/0194481 A1
(43) Pub. Date: Oct. 16, 2003

(54) Method and device for applying fluids to substrates

(75) Inventor: Helge Lippelt, Luneburg (DE)

Correspondence Address: KEVIN G. ROONEY, WOOD, HERRON & EVANS, L.L.P., 2700 CAREW TOWER, CINCINNATI, OH, 45202, US

(73) Assignee: Nordson Corporation

(21) Appl. No.: 10/405,456

(22) Filed: Apr. 2, 2003

(30) Foreign Application Priority Data
Apr. 12, 2002 (EP) 02008425.7

(51) Int. Cl. B05D 1/00

(52) U.S. Cl. 427/8; 118/663; 118/300

(57) ABSTRACT

A device for applying fluids to a moving substrate has at least one nozzle system provided with fluid from a supply channel that is coupled to a fluid source. A valve system cooperating with the nozzle has a valve element that is movable between open and closed positions, relative to an associated valve seat, to selectively dispense fluid from the nozzle. The device further includes at least one sensor configured to sense a position of the valve element relative to the valve seat. Signals from the sensor are utilized by a controller to generate control signals that regulate operation of the valve element.

The present invention relates to a method of applying fluids to substrates, in which the flow of fluid is interrupted and released by movement of a valve body relative to a valve body seat.

The present invention also relates to a device for applying fluid, especially hot melt adhesive, to a substrate which is movable relative to the device, having a supply channel that may be connected with a fluid source for supplying fluid, a nozzle system with an output opening for delivering the fluid that may be fed with fluid via the supply channel, and having a valve system for optionally interrupting the flow of fluid, which has a valve body that is movable relative to a valve body seat, that is movable back and forth between a position that interrupts the flow of fluid and a position that releases the flow of fluid.

Methods of the forenamed type, and corresponding devices for executing them, are used in a large number of applications in which it is necessary to apply fluids. One large area of use is the application of adhesives, paints or enamels, oils or waxes when producing or preserving various products.

When applying fluids, it is normally necessary to control the beginning and end of application precisely, so that the fluid being applied is applied only to certain places on the substrate. It is also desirable in many applications to achieve an interrupted pattern of application of the fluid to the substrate, for example in order to reduce the quantity being applied or to obtain certain properties of the applied layer.

For the forenamed purpose it is known to release or to interrupt the flow of the fluid through the nozzle system by moving the valve body between an open and a closed position. The movement of the valve body is accomplished by actuating devices, such as a solenoid system, a piston-cylinder system, or a pressurized membrane which is connected to the valve body. It is known to regulate the actuating device through laterally controlled signal s [Translator's note: The German-language original has “seitlich gesteuert”=“laterally controlled”; probably intended is “zeitlich gesteuert”=“time-controlled.”], in order to attain the desired times for the beginning and end of application. Coordination of the control signals is complicated, especially if the attempt is being made to achieve short timing sequences of beginning and ending application. For example, in order to attain the desired application pattern the control signals are adjusted iteratively on the basis of the application pattern. In this way a control signal setting is achieved which produces the desired application times, i.e. beginning and end of application, length of application and length of interruption of application. The method of setting these values is complicated, however. Furthermore, when parameters such as the viscosity of the applied fluid change, it is frequently necessary to readjust the application parameters in order to obtain the desired application pattern. These readjustments are time-intensive; in addition, the need for readjustments commonly leads to application results of inadequate quality.

The object of the present invention is therefore to provide an application method and an application device of the aforementioned type, in which simple and reliable recognition and control of the valve body position is possible. The object of the present invention is also to provide a device and a method with which simple and reliable control of the opening and closing times of a previously described application device is possible.

The object is achieved according to the present invention with a method according to claim 1, in that at least one position of the valve body relative to the valve body seat is registered by sensor devices, especially optical sensor devices.

With the help of the sensor device it is therefore possible to register and monitor the movement of the valve body in a simple, mechanical way. It is possible for example to determine whether the function of the valve body and thus of the valve system corresponds to the desired specifications, so that a desired application pattern can thus be achieved.

With the help of the method according to the present invention, it is possible to control or regulate the position, and to control or regulate movement of the valve body depending on the position of the valve body registered by the sensor devices.

In particular, the method according to the present invention may be refined in such a way that the exact position, the maximum travel (amplitude), the velocity, the acceleration and the frequency of the valve body movement are determined from the sensor signals. This may be accomplished through sensor devices that register the forenamed values directly (for example: velocity and acceleration sensors).

The forenamed values may also be determined through time-discrete resolution of the sensor signals of sensor devices which register at least one sensor position. For example, by measuring the time interval between passes of the valve body through a position in the same direction, it is possible to determine the frequency of movement of the valve body (as the reciprocal of this time interval).

In addition, it is possible to determine the mean velocity, assuming that the maximum travel of the valve body is reached, by multiplying the reciprocal of the forenamed time interval by twice the distance of travel.

If there are sensor signals which describe the position of the valve body at consecutive times, it is possible, by creating a position profile curve from these sensor signals and deriving this position profile curve according to the time, to determine the velocity of the valve body at any moment of time.

In addition, by deriving the velocity curve thus obtained according to the time, it is possible to determine the acceleration of the valve body at any moment of time.

The amplitude may be determined in a simple way, by determining the reversal points of the movement (at which the velocity is always zero) and subtracting the displacements of the valve body at these reversal points from each other.

The method may be refined advantageously in such a way that the sensor devices generate a signal depending on the position of the valve body relative to the valve body seat, which is fed into a controller/regulator unit. This controller/regulator unit in turn may generate a control signal which controls the movement of the valve body relative to the valve body seat. This control of the movement of the valve body is preferably accomplished by having the control signal from the controller/regulator unit fed, depending on the signal supplied by the sensor device, to a solenoid valve which controls the supply of pressurized air to a pneumatic piston, the pneumatic piston for its part being linked with the valve body in order to move the valve body. In this way, a closed loop control system is used for the operational sequence of the method according to the present invention, in which the sensor devices register an actual value, namely the position of the valve body, and in which a predetermined desired value is targeted by outputting a control/regulating signal to the actuating device of the valve body.

The method according to the present invention is especially advantageous if there are a plurality of valve bodies present, at least two, whose positions are registered by the sensor devices assigned to the respective valve bodies, and the signals generated by the sensor devices are used to control and/or regulate the time pattern of the movement of the valve bodies, in particular to synchronize the movement. In this way it is possible to regulate the opening and closing times of a plurality of application modules precisely, and to coordinate the time sequence in which a plurality of application modules open and close. It is thus possible to deposit on a substrate in a simpler and reliable way a number of strips of an applied material, which are for example exactly the same length. It is also conceivable for the opening time of one application module to correspond to the closing time of an adjacent application module, and for the opening time of this adjacent application module in turn to correspond to the closing time of the first application module. This results in precise application of parallel interrupted strips of material on the substrate, where adjacent strips have areas next to each other in which application material has been applied in one strip and there is a gap in the application material in an adjacent strip.

The object is achieved by a device according to claim 6. In this device according to the present invention, for executing the method according to the present invention, there are sensor devices which register the position of the valve body relative to the valve seat.

The sensor devices according to the present invention make direct registration of at least one valve body position possible. This direct registration makes it possible to obtain information concerning the actual position and/or information concerning the movement of the valve body, which may be compared for example with the control signals of the actuating device of the valve body. It is therefore no longer necessary to make corrections to the control signals of the actuating device on the basis of the actual application pattern. Instead, it is possible to make corrections to these control signals directly on the basis of the information obtained through the sensor devices. Information is also obtained about whether the valve body is operating properly or not. In many applications, the valve body is moved back and forth at high speed, in order to interrupt or release the flow of fluid through the application device at high frequency.

The sensor devices are positioned in an advantageous way at the end of the valve body opposite the valve seat. This arrangement makes simple and compact construction of the application device possible. In addition, the sensor devices are not in immediate proximity to the application area, so that the danger of soiling the sensor devices is reduced. The end of the valve body is understood here as a zone which extends from the end face of the valve body in the axial direction, and which may thus also be at a distance from the end of the valve body.

The sensor devices are preferably optical sensor devices that work with light in the visible range; wavelengths which lie outside of this range may also be used. The functioning of the optical sensing devices may be based on directing a sensor beam at a section which is connected to the valve body or is a component of the valve body, and registering the radiation reflected from that section. If there are materials with different reflective properties within the section that passes through the irradiated zone when the valve body moves, it is possible to draw conclusions about the position of the valve body on the basis of the quantity of reflected radiation. Preferably, an infrared or ultraviolet range is used.

The functional principle of the sensor device may also be based on irradiating a section connected to the valve body or contained therein, and providing areas within the section that passes through the radiation as the valve body moves which allow the radiation to pass, and areas which do not allow the radiation to pass. In this case, a sensor which receives the radiation is attached in an extension of the line from the radiation source to the irradiated section; this sensor registers the radiation which is passed or blocked by the irradiated section, and is thus able to generate a signal that is related to the actual position of the valve body.

In another advantageous embodiment, the sensor devices include a radiation source and a radiation receiver, where the radiation source directs radiation at a section of the valve body and the radiation receiver receives the radiation reflected by that section of the valve body. On the valve body section there are a plurality of zones, at least two, which are separated from each other in the direction of movement of the valve body and which have different reflective properties. The radiation reflected by the variously reflective zones is related to the position of the valve body, so that the radiation receiver is able to generate a signal which is related to the position of the valve body.

It is especially preferred for the sensor device to include an optical waveguide, which conducts light from a source to the valve body and light reflected from the valve body to a receiver.

In this way it is possible to divide the sensor devices in such a way that the sensor device elements which convert the received light signals into electrical signals are not located in immediate proximity to the valve body. In this way, these sensor device elements are not subjected to the mechanical shocks, soiling and thermal influences which can occur in the vicinity of the valve body. In particular, it is possible to achieve thermal decoupling of the sensor elements which convert the light into electrical values such as resistance, voltage or current, thereby increasing their working life and precision.

The radiation may have in particular a wavelength in the infrared range. This makes the sensor devices less sensitive to soiling and to environmental influences, such as ambient light in the visible range, than if sensor devices are used which work with a wavelength from the visible spectrum.

Another advantageous embodiment of the device according to the present invention comprises a controller and regulator unit, which is able to receive a signal generated by the sensor devices as a function of the position of the valve body and is able to generate a control and regulating signal that controls the movement of the valve body. The controller and regulator unit may operate together with the sensor devices in such a way that predetermined target values, for example for opening and closing times of the valve, are regulated in a closed loop control system, in that the signal generated by the sensor device is processed as the present-state signal in the controller and regulator unit and is compared with the predetermined target value. A control and regulating signal can then be issued to the actuating device of the valve body, for example dependent on the differential of the difference between the target and actual values, the control and regulating signal being chosen so that the target value adjusts itself to the actual value. Within the closed loop control system so constructed, normal regulating procedures of a PID regulator can take place.

Another advantageous embodiment of the present invention comprises a plurality of valve bodies, at least two, all of which work together with sensor devices. Such multiple application heads are known in the related art; the present invention can be utilized advantageously with these multiple application heads, if all of the application modules are provided with sensor devices, so that the position of each valve body in an application module is able to be registered by the respective sensor device.

Here the sensor devices may work together with individual controller and regulator units which are assigned to them, so that individual control and regulation of the individual application modules is possible. The individual controller and regulator units in turn may be connected to a higher-level main regulator unit, which coordinates the timing and the clock rate of the application processes of the individual application modules. There may also be provision for the sensor devices of the individual application modules to be connected to a common regulator unit, preferably a multi-channel regulator unit, which coordinates the regulation and control of the application modules and the timing of the individual application processes of the application modules.

Preferred embodiments of the device according to the present invention and of the method will be explained on the basis of the accompanying drawing. The figures show the following:

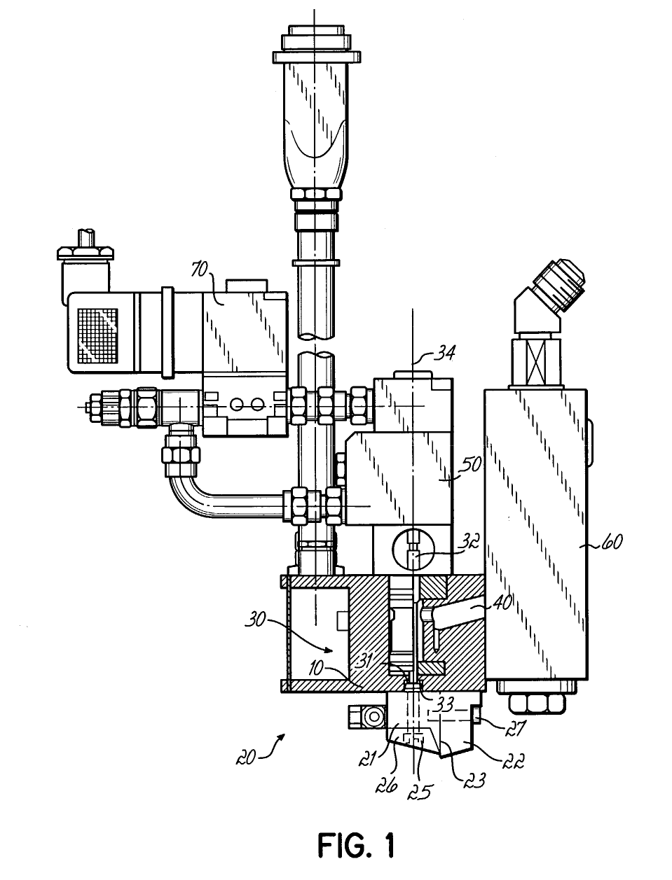

FIG. 1: A device according to the related art for applying fluid (application head), in a cutaway depiction;

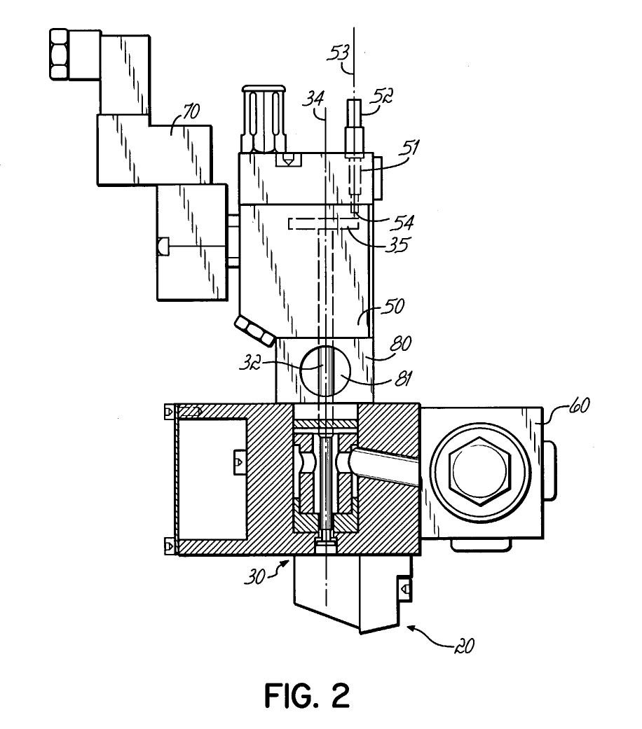

FIG. 2: A cutaway view of a first embodiment of the device according to the present invention;

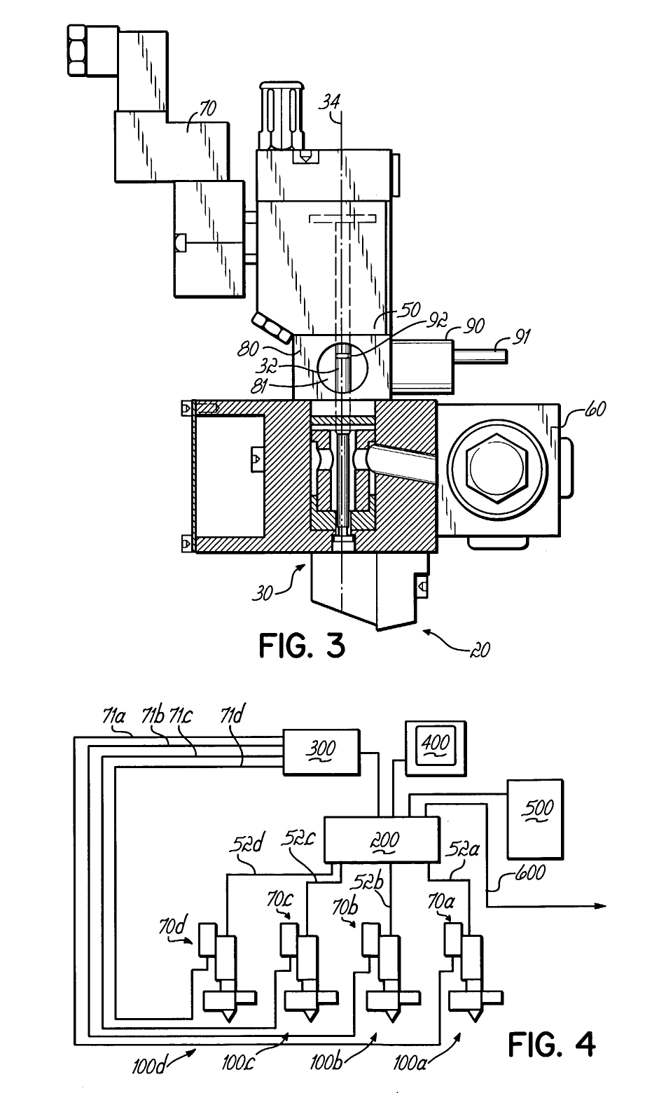

FIG. 3: A cutaway view of a second embodiment of the device according to the present invention;

FIG. 4: A schematic sequence of a preferred embodiment of the method according to the present invention.

The device depicted in FIG. 1 (also referred to below as the application head), displays characteristics of the preferred embodiments of the device according to the present invention. It is suited to the application of liquid or viscous fluids onto substrates, and comprises essentially a metallic basic structure 10, a nozzle system 20 screwed to basic structure 10, a valve system 30, and a controller 50 for actuating valve system 30. In basic structure 10 there is a fluid supply channel 40 which may be connected to a fluid source to supply fluid to nozzle system 20, ahead of which there is a filter 60.

Valve system 30, connected into supply channel 40, has a valve body 32 which is movable together with a valve body sealing surface 31 from an open position to a closed position, which works together with a valve seat 33 formed on basic structure 10 in such a way that the flow of fluid into nozzle system 30 is interrupted in the closed position and is released in the open position. To accomplish this, valve body 32, which is linked to a piston which is movable in a cylinder within controller 50, is moved pneumatically in one direction or the other. The piston is actuated electro-pneumatically in the conventional way by a control device 70, using a solenoid valve. Valve body sealing surface 31 comes into contact with valve seat 33 by moving counter to the direction of flow of the fluid, in order to interrupt the fluid flow. It is located inside a valve chamber formed in the basic structure 10, which valve chamber is part of the supply channel 10 [Translator's note: so numbered in the German original; should be 40] and communicates with a fluid output channel formed in nozzle system 20.

Nozzle system 20 is designed as a slit die and constructed in multiple parts, but other nozzles may be used as desired. It includes a mouth piece 22, a mouth piece holder and a nozzle piece 26. Nozzle system 20 is mounted on basic structure 10 with screws 25, which simultaneously connect nozzle piece 26 to mouth piece holder 21, while mouth piece 22 is detachably connected to mouth piece holder 21 with screws 27, a conventional spacer (shim plate) being placed between the two. Nozzle piece 26 and mouth piece holder 21 are sealed relative to each other by sealing elements.

The fluid output channel formed in nozzle system 20, which communicates with supply channel 40, includes a plurality of sections, specifically one having mouth piece holder 21, a distribution channel essentially formed as a groove in a mouth piece 22, and a slit die 23 constructed between mouth piece holder 21 and mouth piece 22, which opens into a slit-shaped output opening 24 on the lowest section of nozzle system 20, through which fluid may be expelled and applied to the substrate. The distribution channel provides for distribution of the fluid, so that it flows uniformly through slit die 23 in the direction of slit-shaped output opening 24.

Referring to FIG. 2, in which the same reference numbers are used for the corresponding parts as in FIG. 1, a first embodiment of the device according to the present invention has on one side of controller 50 a borehole parallel to the longitudinal axis of valve body 32, through which a first optical waveguide 52 extends. Optical waveguide 52 has a plurality of glass fiber bundles, which are divided into two glass fiber bundle segments. One of the two glass fiber bundles conducts light from a light wave source (not shown) in the direction of the application head shown in FIG. 2, the other glass fiber bundle conducts light waves from the application head to a light wave receiver (not shown).

The longitudinal axis 53 of borehole 51 and of the segment of optical waveguide 52 inserted into the borehole is oriented parallel to the longitudinal axis 34 of the valve body. Borehole 51 and the section of optical waveguide 52 inserted into the borehole are offset laterally from the longitudinal axis 34 in such a way that it is directed toward an edge zone of a piston 35. Piston 35 is connected to valve body 32.

Light which is conducted by optical waveguide 52 to the application head of FIG. 2 emerges at a lower end 54 of optical waveguide 52 and falls on a surface of piston 35 which faces the lower end 54. The light is reflected by piston 35 in the direction of the lower end 54 of optical waveguide 52, since the piston surface irradiated by the optical waveguide is positioned approximately perpendicular to the longitudinal axis of the segment of optical waveguide 52 inserted into borehole 51. The reflected light is thus able to enter into optical waveguide 52 at end 54 and to be conducted to a light wave receiver.

Referring to FIG. 3, in which the same reference numbers are used for the corresponding parts as in FIG. 1, a second embodiment of the device according to the present invention has a connecting piece 80 positioned adjacent to controller 50, having an opening 81 through which valve body 32 may be observed. In this way it is possible for an operator to check whether valve body 32 is in motion or stationary. On the movable, rod-shaped or needle-shaped valve body 32, which may also be referred to as a valve needle, there is a recess in the form of a ring groove 92. Ring groove 92 may be marked in color if appropriate. Through opening 81 it is possible to recognize with the eye whether valve body 32 is in motion or not.

An optical sensor head 90 is attached to connecting piece 80. To make room for optical sensor head 90, filter device 60 of the device according to the present invention is rotated by 90° around an axis that lies horizontal in the image plane of FIGS. 1 and 2. Optical sensor head 90 works together with a second opening (not shown) in connecting piece 80, and is able to shine light on valve body 32 and receive light reflected from valve body 32 through this opening.

Inserted into optical sensor head 90 is an optical waveguide 91, which is able to conduct light waves from a transmitter to the optical sensor and from optical sensor head 90 to a receiver. Optical waveguide 91 is in the form of a glass fiber cable made of a bundle of a plurality of glass fibers. The glass fibers are combined into two bundles of glass fibers. One of the glass fiber bundles serves to conduct light from a transmitter to optical sensor head 90, in order to shine the light on valve body 32. The other glass fiber bundle serves to convey the light reflected from valve body 32, which is received by optical sensor 90, to a receiver. The sensor formed by sensor head 90 preferably works together with the recess in the form of a ring groove 92. The sensitivity of the sensor is improved with the help of ring groove 92.

The embodiments in FIGS. 2 and 3 differ in regard to a different arrangement of the optical waveguides on the application head.

Referring to FIG. 4, it is possible using the method and the device according to the present invention to regulate intermittent application from four application modules 100a-d, and to regulate the coordination of application from these application modules. The application modules have optical waveguides 52a-d, which are inserted at one end into corresponding boreholes in the application module or are connected to a corresponding plug-in sensor on the application module, so that light which is emitted from the optical waveguide at that end falls on the valve body or on a part which is connected to the valve body and moves with it. The light reflected from this part or from the valve body falls in turn on the end of the optical waveguide. The other ends of optical waveguides 52a-d are connected to a regulator unit 200. In this regulator unit 200 there are optical sensor devices for each of the four optical waveguides, which convert the light reflected from the valve body and the light conducted by the optical waveguide into electrical signals.

Controller and regulator unit 200 is connected to a linear path control unit 300. The linear path control unit is a control unit programmable by the operator of the device, which specifies the setting values for the opening and closing times of the valves of modules 100a-d and enables time-dependent programming of the opening and closing times.

Regulator unit 200 is connected individually to control units 70a-d of application heads 100a-d via lines 71a-d. Lines 71a-d carry the electrical control signals which produce pneumatic actuation of the valve bodies.

These control signals may be modified by regulator unit 200 on the basis of the signals transmitted via optical waveguides 52a-d, which represent the present value of the position of the valve body, in order to obtain the desired values specified by linear path control device 300.

Regulator unit 200 is also connected to a display device 400, which displays information about settings, present values and other process-relevant parameters to an operator of the device. Regulator unit 200 is also connected to an analyzing unit 500, which performs an analysis of the deviations of the actual values from the setting values in order to achieve process optimization through changes to the parameters.

It is possible, through a field bus interface 600 implemented as a CAN bus, to connect regulator unit 200 with additional four-channel regulator units, which operate as sub-regulator units. The sub-regulator units (not shown) are connected with each other in turn via a CAN bus. The sub-regulator units contain [Translator's note: The German-language original has “enthalten”=“contain”; probably intended is “erhalten”=“receive.”] the process-relevant parameters and settings via the CAN bus from regulator unit 200, which is used as the master unit, and in turn regulate four application heads through a quadruple light wave input and a quadruple control signal output. This data exchange allows a simple modular construction of application devices having more than four application heads, and separate regulation of each individual application head.

1. A method of applying fluid to a substrate using an applicator having at least one valve element and at least one corresponding valve seat, the method comprising:
moving the valve element relative to the valve seat to selectively release and interrupt the flow of fluid from the applicator; and
sensing at least one position of the valve element relative to the valve seat.

2. The method of claim 1, further comprising:
determining at least one of the velocity, acceleration, and clock frequency of the valve element movement from the sensed position of the valve element.

3. The method of claim 1, further comprising:
generating a sensor signal corresponding to the position of the valve element relative to the valve seat;
sending the sensor signal to a controller/regulator unit; and
generating a control signal that controls the movement of the valve element relative to the valve seat.

4. The method of claim 3, wherein the controller/regulator unit is provided with a setting value curve or a time dependent setting value curve from a programmable unit, and wherein generating the control signal comprises generating the control signal based on the setting value curve and the sensor signal.

5. The method of claim 1, wherein the applicator includes at least two valve elements with corresponding valve seats, the method further comprising:
generating a control signal based on the sensed positions of the at least two valve elements to control the movement of the valve elements relative to the valve seats.

6. A device for applying fluid from a fluid supply to a moving substrate, the device comprising:
a supply channel operatively coupled to the fluid supply;
at least one nozzle system coupled to said supply channel to receive fluid therefrom, said nozzle system having an output opening for dispensing the fluid to the substrate;
a valve system cooperating with said nozzle system for selectively interrupting and releasing the flow of fluid from said output opening, said valve system including a valve element and a valve seat, said valve element movable relative to said valve seat between a position that interrupts fluid flow and a position the releases the fluid flow; and
at least one sensor configured to sense at least one position of said valve element relative to said valve seat.

7. The device of claim 6, wherein said sensor is positioned proximate an end of said valve element, opposite said valve seat.

8. The device of claim 6, wherein said sensor includes a radiation source and a radiation receiver, whereby radiation from said radiation source is directed to said valve element, and radiation reflected from said valve element is received by said radiation receiver.

9. The device of claim 6, wherein said sensor comprises:
a radiation transmitter;
a radiation receiver; and
an optical waveguide communicating with said radiation transmitter and said radiation receiver;
whereby said sensor is spaced from said valve element to isolate said sensor during operation of said valve system, said optical waveguide operable to conduct light from said transmitter to said valve element, and to conduct light reflected from said valve element to said receiver.

10. The device of claim 6, wherein said sensor is configured to operate in the infrared range

11. The device of claim 6, wherein said valve element is configured to provide zones of varying reflectance detectable by said sensor.

12. The device of claim 6, wherein said valve element includes a color marking having different reflective properties relative to an area of said valve element surrounding said color marking, said different reflective properties detectable by said sensor.

13. The device of claim 6, further comprising:
a controller/regulator configured to receive a sensor signal from said sensor and to develop a control signal for controlling movement of said valve element.

14. The device of claim 6, comprising at least two nozzle systems, each having corresponding valve systems with respective valve elements and valve seats, and comprising corresponding sensors configured to sense at least one position of an associated valve element relative to an associated valve seat.

15. The device of claim 14, further comprising a controller configured to receive sensor signals from said sensors and to generate at least one control signal to synchronously control movement of said valve elements.
